(19) United States
(12) Patent Application Publication
(10) Pub. No.: US 2009/0001170 A1
(43) Pub. Date: Jan. 1, 2009

(54) Imaging-Based Bar Code Reader with Image Stabilization

(75) Inventor: Duanfeng He, South Setauket, NY (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: Symbol Technologies, Inc., Holtsville, NY (US)

(21) Appl. No.: 11/771,525

(22) Filed: Jun. 29, 2007

(51) Int. Cl. G06K 7/10

(52) U.S. Cl. 235/462.41

(57) ABSTRACT

An imaging-based bar code reader (10) featuring: an imaging system (20) including an imaging lens assembly (26) and a sensor array (28); an image stabilization system (30) including a sensor system (34) to determine pitch and yaw movements (PM, YM) of the lens assembly (26) and a compensating optical element (26e) moveable along two axes (YL, XL) orthogonal to the optic axis (OA) of the imaging lens assembly (26) to compensate for pitch and yaw movements (PM, YM), the image stabilization system (30) being selectively actuatable; and an image analysis system (31) coupled to the image stabilization system (30), the image analysis system (31) analyzing blurring of an imaged target bar code (14′), when blurring exceeds a threshold value, the image stabilization system (30) being actuated when imaging the target bar code (14) to reduce blurring of the imaged target bar code (14′).

### FIELD OF THE INVENTION

The present invention relates to an imaging-based bar code reader and, more particularly, an imaging-based bar code reader that includes image stabilization to facilitate long-range imaging of bar codes.

### BACKGROUND OF THE INVENTION

Various electro-optical systems have been developed for reading optical indicia, such as bar codes. A bar code is a coded pattern of graphical indicia comprised of a series of bars and spaces having differing light reflecting characteristics. The pattern of the bars and spaces encode information. In certain bar codes, there is a single row of bars and spaces, typically of varying widths, such bar codes are referred to as one dimensional bar codes. Other bar codes include multiple rows of bars and spaces, each typically having the same width, such bar codes are referred to as two dimensional bar codes. Devices that read and decode one and two dimensional bar codes utilizing imaging systems that image and decode imaged bar codes are typically referred to as imaging-based bar code readers or bar code scanners.

Imaging systems include charge coupled device (CCD) arrays, complementary metal oxide semiconductor (CMOS) arrays, or other imaging sensor arrays having a plurality of photosensitive elements or pixels. An illumination system comprising light emitting diodes (LEDs) or other light source directs illumination toward a target object, e.g., a target bar code. Light reflected from the target bar code is focused through a lens of the imaging system onto the pixel array. Thus, an image of a field of view of the focusing lens is focused on the pixel array. Periodically, the pixels of the array are sequentially read out generating an analog signal representative of a captured image frame. The analog signal is amplified by a gain factor and the amplified analog signal is digitized by an analog-to-digital converter. Decoding circuitry of the imaging system processes the digitized signals and attempts to decode the imaged bar code.

One difficulty encountered in reading target objects with encoded indicia, such as target bar codes, involves imaging target objects at long distances from the reader, for example, at distances of more than 2 meters. There are at least two reasons for difficulties in long range imaging: 1) low resolution (or magnification); and 2) low signal-to-noise ratio (SNR) or low quality of other measures related to SNR such as sensitivity or light collection efficiency. The first reason may be mitigated through the use of imaging lens assemblies having increased focal length.

Low SNR is more difficult to improve. At medium distances, say 0.5 to 2 meters, upgrading the reader illumination system such that the illumination system can provide increased illumination intensity at the target bar code may aid in achieving a higher SNR. However, at distances greater than 2 meters providing a more power illumination system is insufficient because as distance between the illumination system and the target bar increases, illumination intensity drops as the square of the distance, that is, illumination is reduced quadratically on the way to the target bar code. Further, the light collected by the imaging lens assembly is also reduced quadratically. If exposure time of the imaging sensor is increased to account for the reduced light collection at greater distances, then image blurring becomes a significant problem. Image blurring typically results from movement of the reader during an exposure period caused by hand jitter of the user when using the reader in a hand-held mode.

What is needed is a way to increase SNR in long ranging imaging situations. What is also needed is a way to account for hand jitter of a user of the reader during a bar code reading session.

### SUMMARY OF THE INVENTION

In one exemplary embodiment, the present invention features an imaging-based bar code reader including: an imaging system including an imaging lens assembly and a sensor array, the imaging lens assembly focusing light from a field of view onto the sensor array to image a target bar code within the field of view, the imaging system generating a series of image frames including the imaged target bar code, the imaging lens assembly defining an optical axis; an image stabilization system including a sensor assembly to determine pitch movement, namely, angular movement of the imaging lens assembly about a first axis orthogonal to and intersecting the optical axis and to determine yaw movement, namely, angular movement of the imaging lens assembly along a second axis orthogonal to and intersecting the optical axis and a compensation element moveable with respect to the first and second axes to compensate for the determined yaw and pitch movements of the imaging lens assembly, the image stabilization system being selectively actuatable; and an image analysis system coupled to the image stabilization system, the image analysis system analyzing blurring of the imaged target bar code, when blurring exceeds a threshold value, the image stabilization system being actuated.

In another exemplary embodiment, the present invention features an imaging-based bar code reader comprising: an imaging system including an imaging lens assembly and a sensor array, the imaging lens assembly focusing light from a field of view onto the sensor array to image a target bar code within the field of view, the imaging system generating a series of image frames including the imaged target bar code, the imaging lens assembly defining an optical axis; an image stabilization system including a sensor assembly to determine pitch movement, namely, angular movement of the imaging lens assembly about a first axis orthogonal to and intersecting the optical axis and to determine yaw movement, namely, angular movement of the imaging lens assembly along a second axis orthogonal to and intersecting the optical axis and a compensation element moveable with respect to the first and second axes to compensate for the determined yaw and pitch movements of the imaging lens assembly, the image stabilization system being selectively actuatable; and a target ranging system coupled to the image stabilization system, the target ranging system determining a distance between the imaging lens assembly and the target bar code, when the determined distance exceeds a threshold value, the image stabilization system being actuated.

These and other objects, advantages, and features of the exemplary embodiment of the invention are described in detail in conjunction with the accompanying drawings.

### BRIEF DESCRIPTION OF THE DRAWINGS

FIG. 1 is a schematic side elevation view of an imaging-based bar code reader of the present invention;

FIG. 2 is a schematic front elevation view of the imaging-based bar code reader of FIG. 1;

FIG. 3 is a schematic top view of the imaging-based bar code reader of FIG. 1;

FIG. 4 schematic sectional view of a portion of the imaging-based bar code reader of FIG. 1 showing the scanner head;

FIG. 5 is a block diagram of an imaging-based bar code reader of FIG. 1 including an image stabilization system of the present invention;

FIG. 6A is a schematic perspective view of a compensation lens of an imaging lens assembly of the reader of FIG. 1, the compensation lens movable to compensate for pitch and yaw movement of the imaging lens assembly;

FIG. 6B is a schematic side elevation view of the compensation lens of FIG. 6A including a schematic representation of a drive system to pivot the lens forward and backward with respect to a horizontal axis of the lens assembly to compensate for pitch movement of the imaging lens assembly;

FIG. 6C is a schematic top plan view of the compensation lens of FIG. 6A including a schematic representation of a drive system to pivot the side to side with respect to a vertical axis of the lens assembly to compensate for yaw movement of the imaging lens assembly;

FIG. 7 is a schematic flow diagram of one exemplary method of image stabilization utilized by the bar code reader of the present invention; and

FIG. 8 is a schematic flow diagram of another exemplary method of image stabilization utilized by the bar code reader of the present invention.

### DETAILED DESCRIPTION

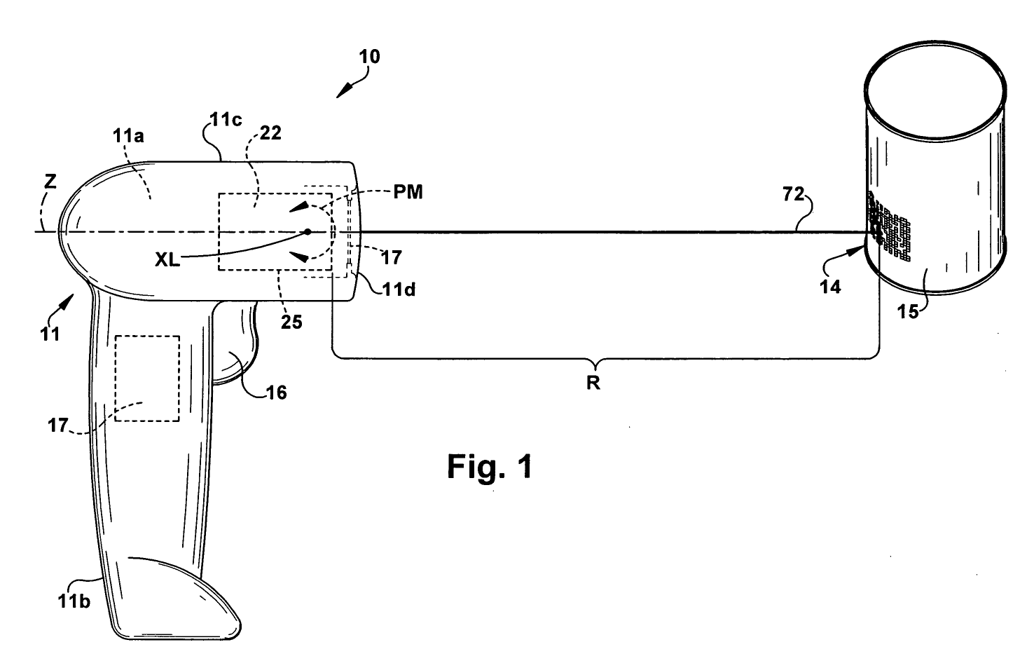

An imaging-based reader, such as an imaging-based bar code reader, is shown schematically at 10 in FIG. 1. The bar code reader 10, in addition to imaging and decoding both 1D and 2D bar codes and postal codes, is also capable of capturing images and signatures. The bar code reader 10 includes an imaging system 20 and a decoding system 40 for capturing image frames of a field of view FV of the imaging system 20 and decoding encoded indicia within a captured image frame. The bar code reader 10 includes a housing 11 supporting the imaging and decoding systems 20, 40 within an interior region 11a of the housing 11.

The imaging and decoding systems 20, 40 operate are part of reader circuitry 12 that includes a microprocessor 13. The imaging system 20 comprises and an imaging camera assembly 22 and associated imaging circuitry 24. The imaging camera 22 includes a housing 25 supporting an imaging lens assembly 26 and an imager 27 comprising a sensor array 28, such as a CCD sensor array. The imager 27 is enabled during an exposure period to capture an image of the field of view FV of the imaging camera assembly 22. Advantageously, the imaging camera 22 is modular, that is, enclosed within the camera housing 25 and capable of being installed in the reader housing 11 as a single unit.

The bar code reader 10 of the present invention includes an image stabilization system 30 which compensates for user hand shake or jitter and makes the reader 10 particularly suited to imaging and decoding target bar codes, such as target bar code 14, at long distances from the reader 10. The imaging stabilization system 30, as will be explained below, compensates for yaw and pitch movements of the imaging camera 22 during a bar code reading session, that is, when the imaging camera 22 is activated to capture image frames 42 of the field of view FV.

Typically, the image stabilization system 30 is part of the imaging system 20, however, it may be an independent system that is electrically coupled to the imaging system circuitry 24. The image stabilization system 30 may be within the camera housing 25 or external to it. To enable the imaging system 20 to determine when the image stabilization system 30 is to be activated, an image analysis system 31 is provided to analyze image frames 42 generated by the imaging system 20 for image blurring. The image analysis system 31 is typically part of the imaging system 20, but may be an independent system that is electrically coupled to the imaging system circuitry 24 and the image stabilization system 30. The imaging analysis system 31 may be part or a subsystem of the imaging stabilization system 30.

For typical size and density bar codes, long distance reading of a target bar code is defined as imaging target bar codes at distances greater than two meters (2 m.) from the reader 10. It should be understood, however, that depending on the specifics of the size (or footprint), configuration (e.g., direct part mark (DPM) bar codes) and density (relative size of the bar code elements) of the target bar code 14, the image stabilization system 30 of the present invention may be advantageously used for imaging bar codes at less than two meters where the size of the target bar code 14 is small, or of high density, or the target bar code has other characteristics making it difficult to image, for example, the target bar code 14 may be a 2D DataMatrix bar DPM bar code marked on a curved surface of an item 15 (as shown in FIGS. 1 & 5). In a DPM bar code, the DataMatrix (or other bar code format) may be represented by a pattern of indented and non-indented surfaces corresponding to black bars and white spaces of a conventional DataMatrix code imprinted on paper. The pattern of indentations may be generated by peening or etching to create craters or indentations on a surface of the item 15.

In one preferred embodiment of the present invention, the bar code reader 10 is a hand held portable reader encased in the pistol-shaped housing 11 adapted to be carried and used by a user walking or riding through a store, warehouse or plant for reading bar codes for stocking and inventory control purposes. However, it should be recognized that the present invention is equally useful in other types of bar code readers or scanners, such as a hand-held computer containing a bar code reader or a bar code reader that can used in a hand-held mode or inserted in a docking station for use in a fixed-position mode. Generally, when used in a fixed position mode, user hand jitter is not an issue and the image stabilization system 30 may be disabled.

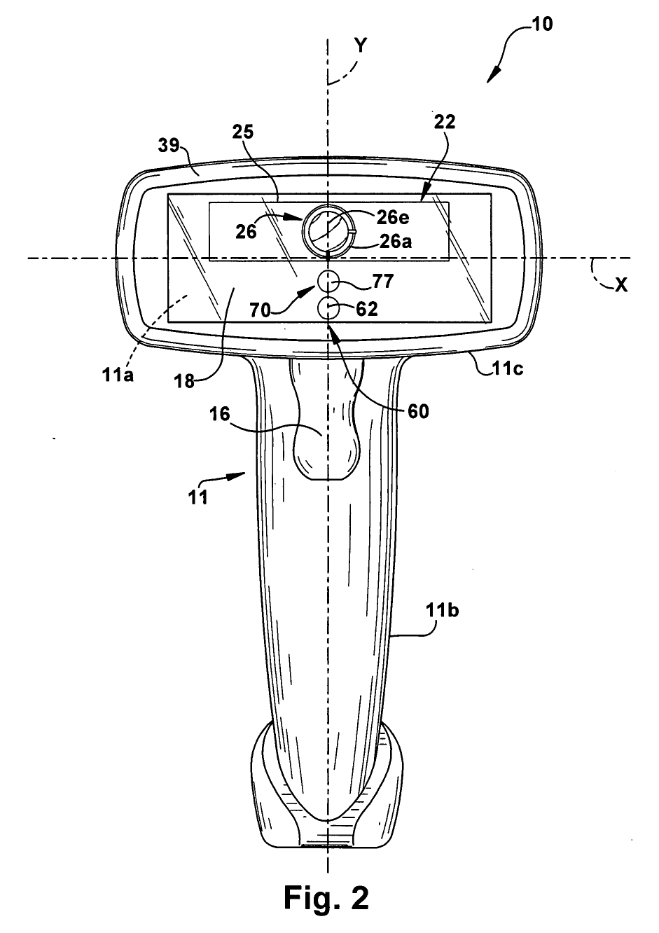

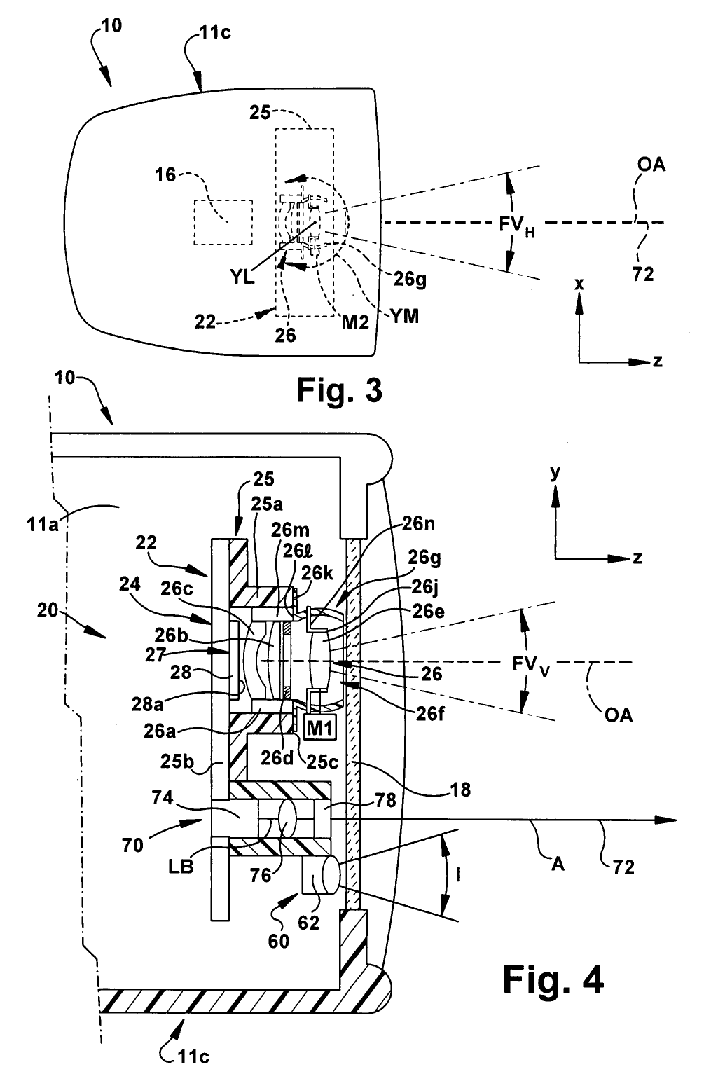

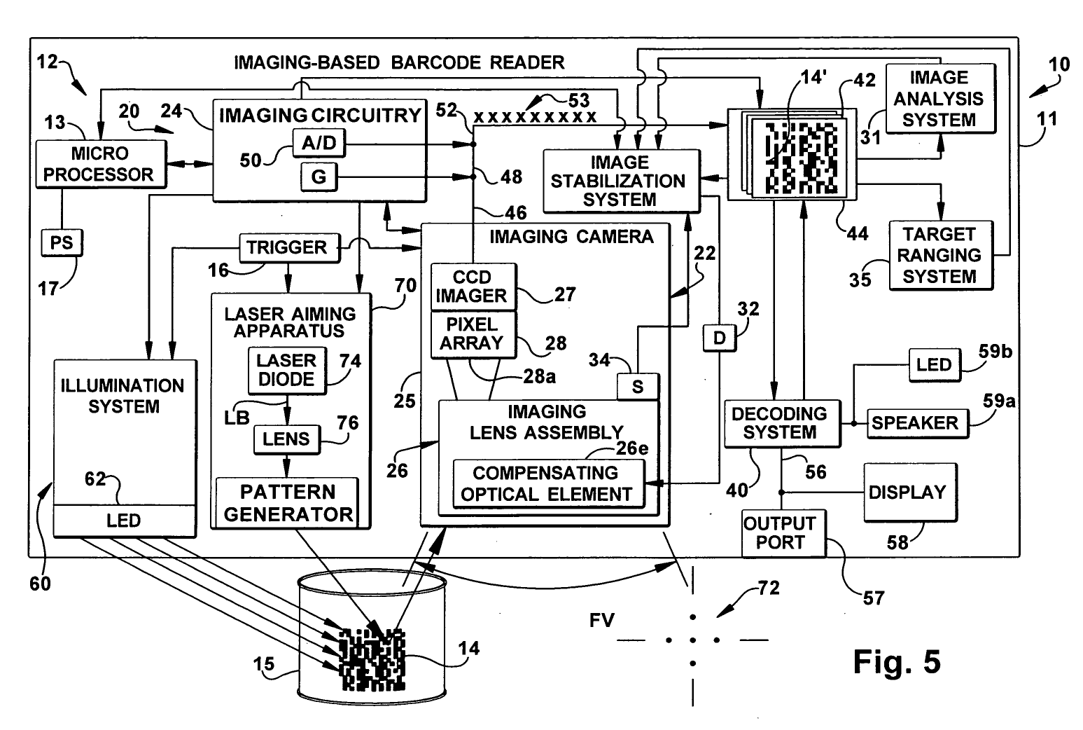

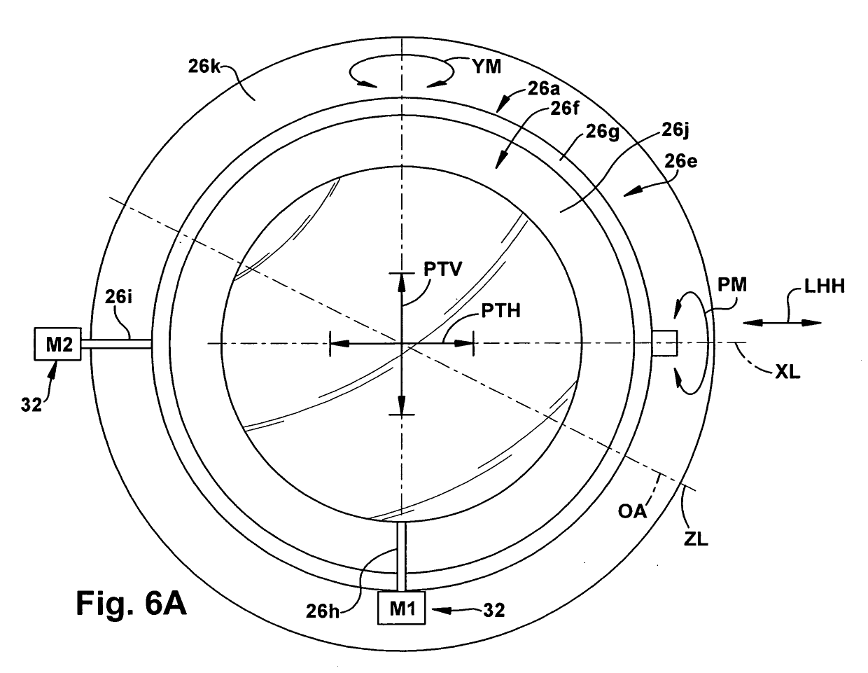

As is best seen in FIGS. 1 and 2, the bar code reader housing 11 includes a generally upright gripping portion 11b adapted to be grasped by a user's hand and a horizontally extending scanning head 11c which supports the imaging assembly 20, an illumination assembly 60 and an aiming apparatus 70. At the intersection of gripping portion 11b and the scanning head 11c is a trigger 16 coupled to bar code reader circuitry 12 for initiating reading of target indicia, such as the target bar code 14, when the trigger 16 is pulled or pressed. The bar code reader circuitry 12, the imaging system 20 and the decoding circuitry 40 are coupled to a power supply 17, which may be in the form of an on-board battery or a connected off-board power supply. If powered by an off-board power supply, the scanner 10 may be a stand-alone unit or have some or all of the scanner's functionality provided by a connected host device. When actuated to read the target bar code 14, the imaging system 20 images a field of view FV (shown schematically in FIG. 5) of the imaging system 20 and generates a series of image frames 42 which are stored in a memory 44. The field of view FV of the imaging system 20 is determined by the optical characteristics of the imaging lens assembly 26 and the size and light receiving active area of the sensor array 28. The field of view FV includes a horizontal field of view FVH (shown schematically in FIG. 3) and a vertical field of view FVV (shown schematically in FIG. 4).

If the target bar code 14 is within the field of view the target bar code 14 during a reading session where the imaging system 20 is activated, each of the series of captured image frames 42 will include a full or partial image 14′ (shown schematically in FIG. 5) of the target bar code 14. Utilizing one or more of the captured image frames 42, the decoding system 40 operates to decode the digitized image 14′ of the target bar code 14.

The imaging and decoding circuitry 24, 40 may be embodied in hardware, software, firmware, electrical circuitry or any combination thereof. The imaging circuitry 24 may be disposed within, partially within, or external to the camera assembly housing 25. Shown schematically in FIG. 4, the imaging camera housing 25 is supported with the scanning head 11c of the housing 11 and receives illumination from the field of view FV including reflected illumination from the target bar code 14, through a transparent window 17 (FIG. 4) supported by the scanning head 11c.

### Imaging Lens Assembly 26

The imaging lens assembly 26 focuses light from a field of view FV of the imaging system 20 onto an active light receiving surface 28a of the sensor array 28. If the target bar code 14 is within the field of view FV, the imaged bar code 14′ will appear in the series of captured image frames 42 generated by the imaging system during a bar code reading session. The imaging lens assembly 26 defines an optical axis OA which is orthogonal to the light receiving surface 28a of the sensor array 28 and typically includes a set of one or more optics lenses and one or more apertures supported by a lens holder 26a. By way of example only, the lens assembly 26 shown schematically in FIG. 4, includes a pair of stationary lenses 26b, 26c positioned rearward of an aperture 26d.

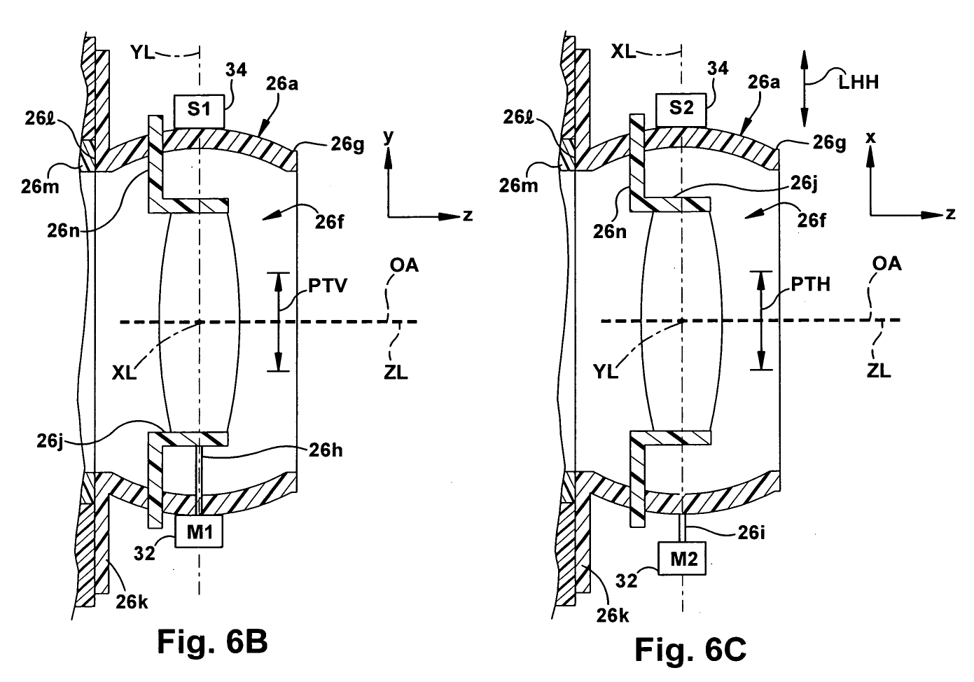

As part of the image stabilization system 30, the lens assembly 26 includes at least one movable compensation element 26e. In one embodiment the compensation element 26e is a movable lens. In one exemplary embodiment, the compensation lens 26e is mounted in an enlarged spherical opening 26f in a horizontally movable distal portion 26g of the lens holder 26a (FIGS. 6B & 6C). The extent of the horizontal movement of the distal portion 26g of the lens holder 26a is shown in FIG. 6C as LHH. The compensation lens 26e is supported in a smaller movable lens holder 26j that moves vertically up and down along the vertical axis YL. The enlarged spherical opening 26e of the lens holder 26a allows movement of the lens holder 26j and the lens 26e in a vertical direction Y with respect to the stationary lenses 26b, 26c, while the horizontally movable distal portion 26g of the lens holder 26a allows movement of the lens 26e in the horizontal direction X with respect to the stationary lenses 26b, 26c.

A drive system 32 comprising a pair of servomotors M1, M2 and supports 26h, 26i provide a drive mechanism to move the compensation lens 26e in an X-Y plane defined by the X (horizontal) and Y (vertical) axes which is orthogonal to the optical axis OA (the Z axis). Advantageously, the compensation lens 26e is movable laterally with respect to the optical axis OA in the X and Y directions both independently and simultaneously.

As can best be seen in FIG. 6B, within the distal portion 26g of the lens holder 26a, the lens 26e is held within the smaller movable lens holder 26j which, in turn, is supported on a vertical oriented support 26h. The vertical support 26h extends through the lens holder 26a is operatively coupled to the servomotor M1. When the motor M1 is actuated, the vertical support 26h is driven in a vertical direction by the servomotor M1 such that the lens 26e is driven vertically along a path of travel PTV along the vertical axis YL of the lens assembly 26.

As can best be seen in FIG. 6C, a horizontal support 26i is coupled to the lens holder distal portion 26g. The horizontal support 26i, in turn, is operatively coupled to a second servomotor M2. When the servomotor M2 is actuated, the motor drives the support 26i in a horizontal direction H such that the lens 26e is driven horizontally along a path of travel PTH along the horizontal axis of the lens assembly 26. The servomotor M2 cause horizontal movement of the lens via the operative connection of support 26i, movable lens holder portion 26g and support 26h. Thus, the compensation lens 26 is simultaneously and independently movable along the horizontal axis XL and the vertical axis YL of the lens assembly 26.

As best seen in FIGS. 6A, 6B and 6C, the smaller movable lens holder 26j includes a radially outwardly extending flank or flange 26n at its proximal end that extends through an mating opening in the larger movable lens holder 26g to block light and prevent ambient illumination entering the distal portion 26g from bypassing the compensation lens 26e and being focused onto the sensor array 28 by the fixed lenses 26b, 26c. Similarly, as is best seen in FIGS. 4, 6A, 6B and 6C, the movable lens holder 26g includes a radially outwardly extending flank or flange 26k at its proximal end that abuts an end 261 of a stationary portion 26m of the lens holder 26a and a distal end 25c of the shroud 25a to block light and present ambient illumination from entering the stationary portion 26m of the lens holder 26a as the movable lens holder 26g lens moves laterally with respect to the stationary portion 26m.

One of skill in the art would recognize that there are numerous variations and types of drive mechanisms to cause precise lateral movement of the compensation lens 26e in the x-y plane orthogonal to the z axis and it is the intent of the present invention to cover all such conventional drive mechanisms.

The camera housing 25 includes a shroud 25a that supports and seals against the lens holder 26a so that the only illumination incident upon the sensor array 28 is illumination passing through the focusing lens 26. The lens holder 26a is typically made of metal or plastic. A back end of the housing 25 may be comprised of a printed circuit board 25b, which forms part of the imaging circuitry 24 and may extend beyond the housing 25 to support the illumination system 60 and the laser aiming apparatus 70.

### Imaging and Decoding

The imaging system 20 includes the imager 27 of the imaging camera assembly 22. The imager 27 comprises a charged coupled device (CCD), a complementary metal oxide semiconductor (CMOS), or other imaging pixel array, operating under the control of the imaging circuitry 24. In one exemplary embodiment, the sensor array 28 of the CCD imager 27 comprises a two dimensional (2D) mega pixel array with a typical size of the pixel array being on the order of 1280×1024 pixels. The pixel array 28 is secured to the printed circuit board 25b, in parallel direction for stability.

As is best seen in FIG. 4, the imaging lens assembly 26 focuses light reflected from the target bar code 14 through an aperture 26d onto the pixel/photosensor array 28 of the CCD imager 27. Thus, the lens assembly 26 focuses an image of the target bar code 14 (assuming it is within the field of view FV) onto the array of pixels comprising the pixel array 28. The lens assembly field of view FV includes both a horizontal and a vertical field of view, the horizontal field of view being shown schematically as FVH in FIG. 3 and the vertical field of view being shown schematically as FVV in FIG. 4.

Electrical signals are generated by reading out of some or all of the pixels of the sensor array 28 after an exposure period. After the exposure time has elapsed, some or all of the pixels of sensor array 28 are successively read out thereby generating an analog signal 46 (FIG. 5). In some sensors, particularly CMOS sensors, all pixels of the sensor array 28 are not exposed at the same time, thus, reading out of some pixels may coincide in time with an exposure period for some other pixels.

The analog image signal 46 represents a sequence of photosensor voltage values, the magnitude of each value representing an intensity of the reflected light received by a photosensor/pixel during an exposure period. The analog signal 46 is amplified by a gain factor, generating an amplified analog signal 48. The imaging circuitry 24 further includes an analog-to-digital (A/D) converter 50. The amplified analog signal 48 is digitized by the A/D converter 50 generating a digitized signal 52. The digitized signal 52 comprises a sequence of digital gray scale values 53 typically ranging from 0-255 (for an eight bit processor, i.e., 2⁸=256), where a 0 gray scale value would represent an absence of any reflected light received by a pixel (characterized as low pixel brightness) and a 255 gray scale value would represent a very intense level of reflected light received by a pixel during an integration period (characterized as high pixel brightness).

The digitized gray scale values 53 of the digitized signal 52 are stored in the memory 44. The digital values 53 corresponding to a read out of the pixel array 28 constitute the image frame 42, which is representative of the image projected by the imaging lens system 26 onto the sensor array 28 during an exposure period. If the field of view FV of the imaging lens system 26 includes the target bar code 14, then a digital gray scale value image 14′ of the target bar code 14 would be present in the series of image frames 42.

The decoding circuitry 40 then operates on the digitized gray scale values 53 of a selected one or more of the series of image frames 42 and attempts to decode any decodable image within the image frame, e.g., the imaged target bar code 14′. If the decoding is successful, decoded data 56, representative of the data/information coded in the bar code 14 is then output via a data output port 57 and/or displayed to a user of the reader 10 via a display 58. A more detailed description of imaging and decoding is set forth in U.S. Ser. No. 11/032,767, filed Jan. 10, 2006 and entitled “Barcode Scanner Decoding.” U.S. Ser. No. 11/032,767 is assigned to the assignee of the present invention and is incorporated herein in its entirety by reference. Upon achieving a good “read” of the bar code 14, that is, the bar code 14 was successfully imaged and decoded, a speaker 59a and/or an indicator LED 59b is activated by the bar code reader circuitry 13 to indicate to the user that the target bar code 14 has successfully read, that is, the target bar code 14 has been successfully imaged and the imaged bar code 14′ has been successfully decoded.

### Illumination and Aiming Systems 60, 70

The imaging camera 22 further includes the illumination assembly 60 for directing a beam of illumination to illuminate the target bar code 14 and the aiming apparatus 70 for generating a visible aiming pattern 72 (FIG. 5) to aid the user in properly aiming the reader at the target bar code 14. The illumination assembly 60 and the aiming apparatus 70 operate under the control of the imaging circuitry 24. As can best be seen in FIGS. 2-4, in one preferred embodiment, the illumination assembly 60 is a single LED 62 producing a wide illumination angle to completely illuminate the target bar code 14.

The LED 62 is supported within the scanning head 11b just behind the transparent window 17 and face forwardly, that is, toward the target bar code 14. The LED 62 is positioned away from the focusing lens 26 to increase the illumination angle (shown schematically as I in FIG. 4) produced by the LED 62. Preferably, the illumination provided by the illumination assembly 60 is intermittent or flash illumination as opposed to continuously on illumination to save on power consumption. Also, preferably, the LED 62 is red at the higher end of the red wavelength range, e.g., approximate wavelength around 670 nanometers (nm.), since red LEDs of this wavelength have been found to provide for efficient conversion of electrons to photons by the LEDs and from photons back to electrons by the photosensor array 28.

In one exemplary embodiment, the aiming apparatus 70 is a laser aiming apparatus. The aiming pattern 72 may be a pattern comprising a single dot of illumination, a plurality of dots and/or lines of illumination or overlapping groups of dots/lines of illumination (FIG. 5). The laser aiming apparatus 70 includes a laser diode 74, a focusing lens 76 and a pattern generator 77 for generating the desired aiming pattern 77. The laser diode 74, the lens 76 and the pattern generator are supported by a lens holder 78 which extends from the printed circuit board 25b. Typically, the laser diode emits a red colored illumination on the shorter end of the red wavelength range e.g., 625 nm., which is easier to discern to the human eye than red color having a longer wavelength. Alternately, the laser diode 74 may emit a yellow, green or yellow-green colored illumination (approximate wavelengths—green—492-577 nm., yellow—577-597 nm.) because a yellow-green color provides excellent visibility to a user of the reader 10. The aiming apparatus 70 is supported in the scanning head 11b and the aiming pattern exits the head through the transparent window 17.

Operating under the control of the imaging circuitry 24, when the user has properly aimed the reader 10 by directing the aiming pattern 72 onto the target bar code 14, the aiming apparatus 70 is turned off when an image of the target bar code 14 is acquired such that the aiming pattern 72 does not appear in the captured image frame 42. Intermittently, especially when the scanner imaging circuitry 24 is transferring the captured image frame 42 to memory 44 and/or when processing the image, the aiming apparatus 70 is turned back on. If the decoding circuitry 40 cannot decode the imaged bar code 14′ and the user in the mean time has not released the trigger 12, the process of acquiring an image of the target bar code 14 set forth above is repeated.

### Image Stabilization System 30

As mentioned above, the reader 10 of the present invention advantageously includes an image stabilization system 30 to provide enhanced capability of long range reading of target objects such as the target bar code 14. By way of example, long range reading includes distances from the target bar code 14 to the camera assembly 22 of two meters or more. In one exemplary embodiment, the image stabilization system 30 is part of the imaging system 20 and includes a compensation element, namely, the compensation lens 26e of the imaging lens assembly 26 and associated drive mechanism 32 including servomotors M1, M2. The image stabilization system 30 further includes a sensor system 34 to discern movement of the reader 10.

In one exemplary embodiment, the sensor system 34 includes a pair of motion sensors such as angular movement sensors S1 and S2 (FIGS. 6B and 6C, respectively) which are mounted on the exterior of the imaging lens assembly lens holder 26a. Movement sensor S1 detects rotational motion of the reader 10 with respect to a horizontal axis x (FIG. 2) of the reader. Stated another way, sensor S1 detects angular movement of the lens assembly 26 of the imaging camera 22 with respect to the horizontal axis XL of the imaging lens assembly. Stated another way, movement sensor S2 detects rotational motion of the reader 10 with respect to a vertical axis v (FIG. 2) of the reader 10. Sensor S2 detects angular movement of the lens assembly 26 of the imaging camera 22 with respect to the vertical axis VL of the imaging lens assembly 26.

In one embodiment, the sensors S1, S2 detect movement in the form of angular velocity, that is, sensor S1 detects movement of the lens assembly 26 of the imaging camera 22 with respect to the horizontal axis XL, while movement sensor S2 detects movement of the lens assembly 26 of the imaging camera 22 with respect to the vertical axis VL. As can be seen in FIG. 6A, the axes XL and VL of the imaging assembly 26 are orthogonal to and intersect each other and intersect the optical axis OA, which is congruent with axis ZL.

The sensor S1 detects angular velocity with respect to horizontal axis XL that corresponds to a condition called pitch movement PM (FIGS. 1 and 6A) of the reader 10, while the sensor S2 detects angular velocity with respect to the vertical axis YL that corresponds to a condition called yaw movement YM (FIG. 6A) of the reader 10. Both pitch and yaw movement can cause blurring of the imaged bar code 14′ in a captured image frame 42.

The image analysis system 31, which is either part of the image stabilization system 30 or is in communication with the image stabilization system 30, analyzes the series of captured image frames 42 during a reading session. If it is determined that the image quality is below a predetermined image quality threshold level or value, that is, if the imaged bar code 14′ exhibits an unacceptable level of blurry such that decoding is either impossible or would take an unacceptably long time, the image stabilization system 30 is activated compensate for the pitch and/or yaw movement that is contributing to the blurring problem. Advantageously, target bar codes 14 have sharp edges, that is, well defined lines of demarcation between the bars and the spaces. Thus, to the extent blurring exists in an imaged bar code, there can only be two sources of blurring: 1) the lens assembly 26; and 2) movement of the camera 22 due to hand jittering. Assuming that the lens assembly 26 is of sufficient quality such that blurring is at a known, acceptable level, any additional blurring above and beyond the known, acceptable level resulting from the lens assembly 26 may be attributed to camera movement.

More specifically, when the image stabilization system 30 is activated, if the sensor S1 determines that angular velocity is occurring with respect to the horizontal axis XL, this indicates that pitch movement of the reader 10 is occurring (as shown schematically in FIGS. 1 and 6A). Pitch movement (labeled as PM in FIG. 6A) is rotation of the reader 10 about the horizontal axis x or, equivalently, a rotation of the camera 22 about the horizontal axis XL. In response, the image stabilization system 30 activates the motor M1 to move the compensation lens 26e vertically along the axis VL in a direction and distance along its vertical path of travel PTV opposing the pitch movement so as to negate the effect of the pitch movement and thereby reduce image blurring by providing a stabilized image directed onto the sensor array 28. Stated another way, to the extent hand jitter of a user of the reader 10 causes the camera 22 to experience a pitch movement, the image stabilization system 30, when activated, counters the pitch movement to provide a stabilized, more clearly focused image on the sensor array 28. Since the exposure times for imaging and decoding a target bar code increases with increasing distance to the target bar code, the need for a stable image increases with exposure time and distance to the target bar code.

It should be noted that rotation of the reader 10 is generally the same for the reader 10 taken as a whole or any part of it, such as the camera 22. For example for pitch movement PM, the pitch movement is independent of the horizontal axis (x or XL) that is chosen. The same applies to yaw movement. Compared to rotations of the reader 10, lateral movements of the reader 10 vertically or horizontally do not cause as much blurring as rotational movement and, therefore, lateral movements of the reader are not compensated for by the image stabilization system 30.

Similarly, with respect to yaw movement (labeled as YM in FIG. 6A), when the image stabilization system 30 is activated, if the sensor S2 determines that angular velocity is occurring with respect to the vertical axis VL, this indicates that yaw angular movement of the camera assembly 22 is occurring (as shown schematically in FIGS. 3 and 6A). Yaw angular movement is rotation of the reader 10 about the vertical axis v or, equivalently, rotation of the camera 22 about the vertical axis VL. In response, the image stabilization system 30 activates the motor M2 to move the compensation lens 26e horizontally along the horizontal axis XL in a direction and distance along its horizontal path of travel PTH opposing the yaw movement so as to negate the effect of the yaw movement and thereby reduce image blurring by providing a stabilized image directed onto the sensor array 28. Stated another way, to the extent hand jitter of a user of the reader 10 causes the camera 22 to experience a yaw movement, the image stabilization system 30, when activated, counters the yaw movement to provide a stabilized, more clearly focused image on the sensor array 28.

It should be noted that a third type of angular movement of the camera assembly 22, namely, roll angular movement is not accounted for. Roll angular movement is rotation with respect to a front to back or ZL axis through the camera assembly. The ZL axis is congruent with the optical axis OA of the lens assembly 26. Roll movement is less likely to be caused by hand jitter than pitch and yaw movement of the camera assembly 22. Further, even when roll movement does occur, it is generally of a smaller magnitude than pitch or yaw movement. Accordingly, roll movement of the camera assembly 22 will generally cause less distortion and therefore less blurring of the imaged target bar code 14′ than yaw or pitch movement would cause distortion. The axes XL, VL and ZL of the compensation lens 26e are parallel to the reader axes x, y and z, shown in Figures.

As will be understood by one of skill in the art, the compensation element 26e, which in one exemplary embodiment is a moveable lens, may be an element other than a lens, for example it may be a rotating or pivotable mirror or prism. Alternately, the drive system could move the entire lens assembly so long as there is appropriate movement to counteract the effect of pitch and yaw movement of the camera assembly 22.

### Methods of Image Stabilization 100, 200

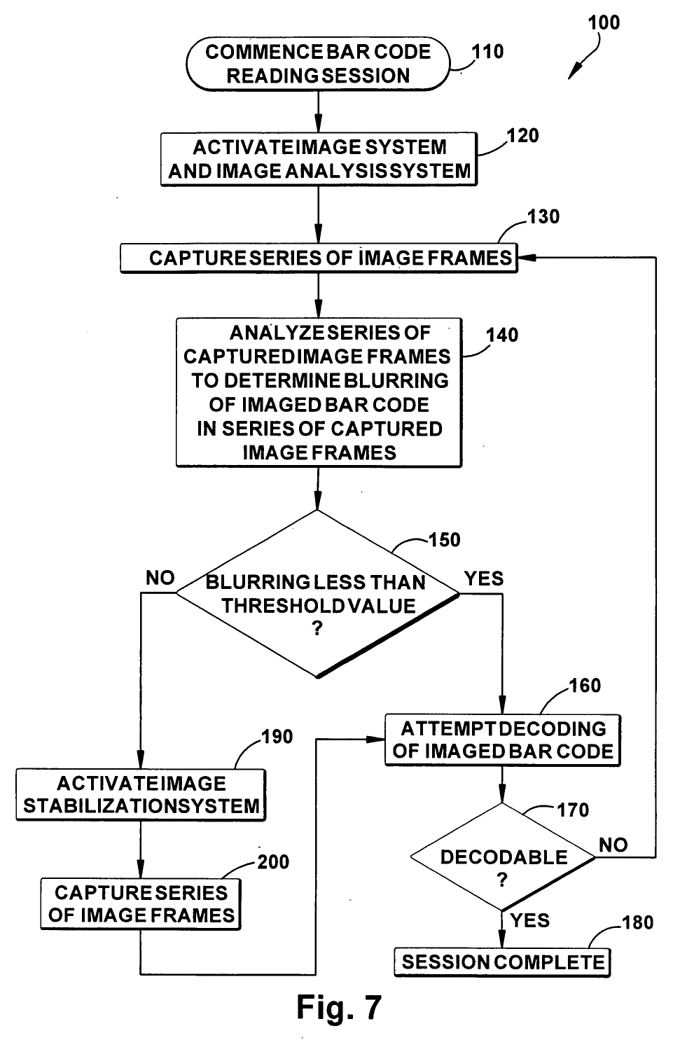

FIG. 7 presents a schematic flow chart for the method shown generally at 100, used to provide image stabilization. At step 110, a bar code reading session is commenced by a user pulling the trigger 16. At step 120, the imaging system 20 and the image analysis system 31 are activated. At step 130, the imaging system 20 captures a series of image frames 42 of the field of view FV of the imaging system. At step 140, the image analysis system 31 analyzes one or more of the captured image frames 42 and determines if the captured image frame or frames selected for analysis include an image 14′ of the target bar code 14, if so, the image analysis system 31 determines a degree of image blurring of the imaged bar code 14′.

At step 150, the image analysis system 31 compares the degree or amount of blurring of the imaged bar code 14′ to a threshold value of blurring that has been established or has been input to the image analysis system 31. Typically, the threshold value is established based on a degree of blurring that typically would prevent successful decoding of the imaged bar code 14′ by the decoding system 40. At step 160, if it is determined that the blurring value of the imaged bar code 14′ is acceptable, that is, less than the threshold value of blurring, then decoding of the imaged bar code 14′ is attempted. At step 170, if the imaged bar code 14′ is found to be decodable, then at step 180, the reading session is completed and a signal is provided to the user to indicate a successful reading of the target bar code 14 via the speaker 59a or the LED 59b.

If at step 170, the image bar code 14′ is found not to be decodable, the process returns to step 130 and the process continues as described previously. If at step 150, the blurring value of the imaged bar code 14′ is equal to or greater than the threshold value of blurring, then, at step 190, the image stabilization system 30 is activated. At step 200, a new series of image frames 42 is captured. Assuming that one or more of the captured image frames 42 includes the imaged bar code 14′, the process moves to step 160 wherein the decoding circuitry attempts to decode the imaged bar code 14′. The process then continues at step 170, as described above.

### Second Exemplary Embodiment of Image Stabilization Process

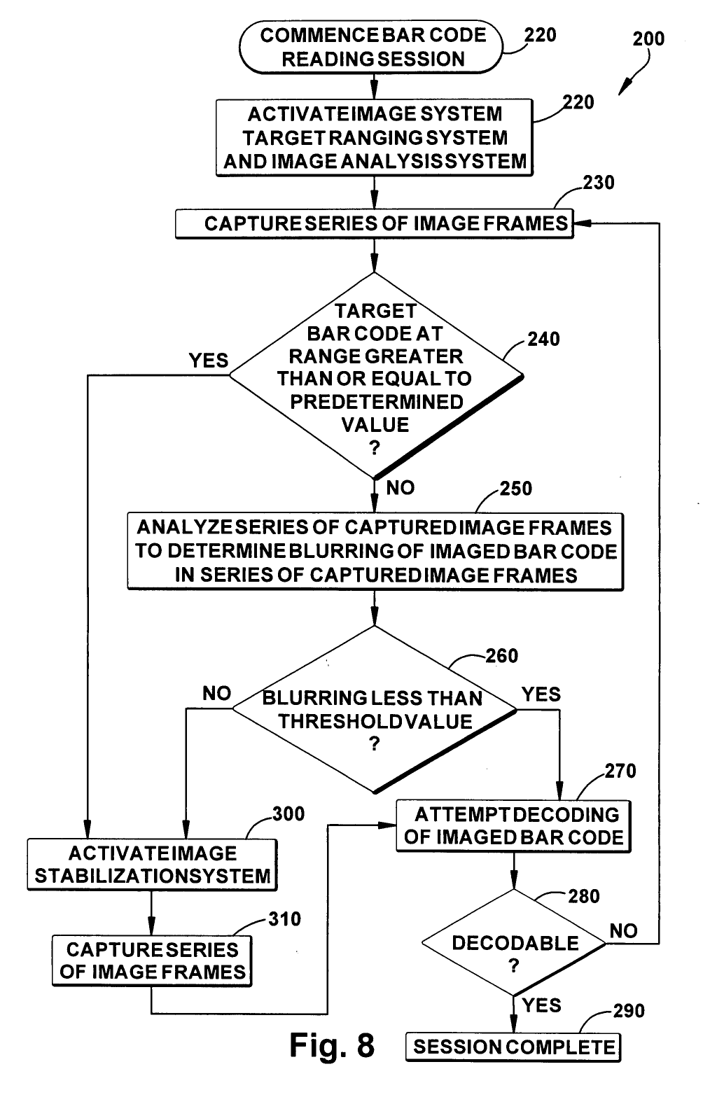

A second exemplary embodiment of the image stabilization process is schematically shown at 200 in FIG. 8. In this embodiment, the reader 10 is presumed to additionally include a target ranging system (shown schematically in FIG. 5 as 35) for determining a distance or range R from the target bar code 14 to be imaged to the camera assembly 22. If the target range R (shown in FIG. 1) is found to be greater than or equal to a predetermined range value, for example, two meters, then the image stabilization system 30 is activated.

One type of target ranging system is a laser ranging system which relies on the laser aiming apparatus 70. Since the laser aiming apparatus (as seen in FIG. 4) is spaced from the optical axis OA of the lens assembly 26 because of parallax, an image of the aiming pattern 72 projected onto the sensor array 28 would be offset from a center of the sensor array light receiving surface 28a. The extent to which an image of the aiming pattern 72 is offset from the center of the sensor array 28 can be used by the laser ranging system 35 to very accurately determine the distance R to the target bar code 14.

A suitable laser ranging system for an imaging-based bar code reader is disclosed in U.S. Ser. No. 10/903,792, filed Jul. 30, 2004 and entitled “Automatic Focusing System for Imaging-Based Bar Code Reader.” The '792 application is assigned to the assignee of the present invention and is incorporated herein in its entirety by reference.

FIG. 8 presents a schematic flow chart for a second method shown generally at 200, used to provide image stabilization. At step 210, a bar code reading session is commenced by a user pulling the trigger 16. At step 220, the imaging system 20, the target ranging system 35 and the image analysis system 31 are activated. At step 230, a series of image frames of the field of view FV is captured and, if an image 14′ of the target bar code 14 is found, the target ranging system 35 determines a distance or range to the target bar code 14. At step 240, the target ranging system 35 determines if the distance to the target bar code 14 is equal to or greater than a predetermined threshold distance. If the determination at step 240 is no, that is, the target bar code 14 is relatively close to the camera 22, then at step 250, the image analysis system 31 analyzes one or more of the captured image frames 42 and determines if the captured image frame or frames selected for analysis include an image 14′ of the target bar code 14, if so, the image analysis system 31 determines a degree of image blurring of the imaged bar code 14′.

At step 260, the image analysis system 31 compares the degree or amount of blurring of the imaged bar code 14′ to a threshold value of blurring that has been established or has been input to the image analysis system 31. At step 270, if it is determined that the blurring value of the imaged bar code 14′ is acceptable, that is, less than the threshold value of blurring, then decoding of the imaged bar code 14′ is attempted. At step 280, if the imaged bar code 14′ is found to be decodable, then at step 290, the reading session is completed and a signal is provided to the user to indicate a successful reading of the target bar code 14 via the speaker 59a or the LED 59b.

If at step 280, the image bar code 14′ is found not to be decodable, the process returns to step 230 and the process continues as described previously. If at step 240, the target bar code 14 is found by the target ranging system 35 to be equal to or greater than the predetermined threshold value of distance, then at step 300, the image stabilization system 30 is activated. At step 310, a new series of image frames 42 is captured and the process moves to step 270, as described above, where decoding of the imaged bar code 14′ (assuming it is present in one or more of the captured image frames 42) is attempted.

If at step 260, the blurring value of the imaged bar code 14′ is equal to or greater than the threshold value of blurring, then, at step 300, the image stabilization system 30 is activated. At step 310, a new series of image frames 42 is captured. Assuming that one or more of the captured image frames 42 includes the imaged bar code 14′, the process moves to step 270 wherein the decoding circuitry attempts to decode the imaged bar code 14′. The process then continues at step 280, as described above.

It should be recognized that the method described above could be simplified by eliminating the image analysis system 31. If this were done, activation of the image stabilization system 30 would be dependent solely upon whether the target distance or range R was equal to or greater than the predetermined threshold distance value (e.g., whether the distance R was greater than or equal to two meters).

Since power draw is always a great concern in portable bar code reader which relies on an internal power supply 16, advantageously, as can be seen from the foregoing methods, the image stabilization system 30 of the present invention is only actuated when needed. That is, only when target distance R or imaging blurring require image stabilization is the image stabilization system 30 actuated. Further, unlike many image stabilization systems, the system 30 of the present invention does not require user selection or activation, the determination of the need for image stabilization and the activation of the image stabilization system 30 is completely transparent to the user. Additionally, the image stabilization system 30 of the present invention is an optical-based system as opposed to an electronic system, which is less accurate than optical image stabilization systems. A description and comparison of the optical-based and electronic-based imaging stabilization techniques are discussed in an article entitled “Image Stabilization Technology Overview” by David Sachs, Steven Nasiri and Daniel Goehl of InvenSense, Inc., Santa Clara, Calif. (www.InvenSense.com). The aforesaid article is incorporated in its entirety by reference herein.

While the present invention has been described with a degree of particularity, it is the intent that the invention includes all modifications and alterations from the disclosed design falling within the spirit or scope of the appended claims.

I claim:

1. An imaging-based bar code reader comprising:
an imaging system including an imaging lens assembly and a sensor array, the imaging lens assembly focusing light from a field of view onto the sensor array to image a target bar code within the field of view, the imaging system generating a series of image frames including the imaged target bar code, the imaging lens assembly defining an optical axis;
an image stabilization system including a sensor assembly to determine pitch movement, namely, angular movement of the imaging lens assembly about a first axis orthogonal to and intersecting the optical axis and to determine yaw movement, namely, angular movement of the imaging lens assembly along a second axis orthogonal to the first axis and the optical axis and a compensation element moveable with respect to the first and second axes to compensate for the determined yaw and pitch movements of the imaging lens assembly, the image stabilization system being selectively actuatable; and
an image analysis system coupled to the image stabilization system, the image analysis system analyzing blurring of the imaged target bar code, when blurring exceeds a threshold value, the image stabilization system being actuated.

2. The imaging-based bar code reader of claim 1 wherein the first axis is a horizontal axis through the imaging lens assembly and the second axis is a vertical axis through the imaging lens assembly, the first and second axes intersecting.

3. The imaging-based bar code reader of claim 2 wherein the compensation element includes a compensation lens that moves along the first axis to compensate for determined yaw movement and along the second axis to compensate for determined pitch movement.

4. The imaging-based bar code reader of claim 3 wherein the compensation lens is supported for movement in a plane orthogonal to the optical axis within a lens holder of the imaging lens assembly.

5. The imaging-based bar code reader of claim 1 wherein the sensor assembly includes a first sensor to determine angular velocity of the imaging lens assembly with respect to the first axis and a second sensor to determine angular velocity of the imaging lens assembly with respect to the second axis.

6. The imaging-based bar code reader of claim 5 wherein the first and second sensors are disposed on a lens holder of the imaging lens assembly.

7. The imaging-based bar code reader of claim 4 wherein a drive system is operatively coupled to the compensation lens to move the lens along the second axis in a direction to oppose determined angular movement about the first axis to counteract pitch movement and to move the lens along the first axis in a direction to oppose determined angular movement about the second axis to counteract yaw movement.

8. The imaging-based bar code reader of claim 7 wherein the drive system includes a first motor operatively connected to the compensation lens to drive the lens along the second axis and a second motor operatively connected to the compensation lens to drive the lens along the first axis.

9. The imaging-based bar code reader of claim I further including a target range system to determine a distance from a target bar code to the imaging lens assembly, the image stabilization system being activated when a determined distance exceeds a threshold distance value.

10. A method of imaging a target bar code within a field of view of an imaging-based bar code reader, the steps of the method comprising:
a) providing an imaging system including an imaging lens assembly and a sensor array, the imaging lens assembly focusing light from the field of view onto the sensor array to image a target bar code within the field of view, the imaging system generating a series of image frames including the imaged target bar code, the imaging lens assembly defining an optical axis; an image stabilization system including a sensor assembly to determine pitch movement, namely, angular movement of the imaging lens assembly about a first axis orthogonal to and intersecting the optical axis and to determine yaw movement, namely, angular movement of the imaging lens assembly along a second axis orthogonal to and intersecting the optical axis and a compensation element moveable with respect to the first and second axes to compensate for the determined yaw and pitch movements of the imaging lens assembly, the image stabilization system being selectively actuatable; and an image analysis system coupled to the image stabilization system, the image analysis system analyzing blurring of the imaged target bar code, when blurring exceeds a threshold value, the image stabilization system being actuated; and
b) activating the imaging system and the image analysis system and imaging the target bar code.

11. An imaging-based bar code reader comprising:
an imaging system including an imaging lens assembly and a sensor array, the imaging lens assembly focusing light from a field of view onto the sensor array to image a target bar code within the field of view, the imaging system generating a series of image frames including the imaged target bar code, the imaging lens assembly defining an optical axis;
an image stabilization system including a sensor assembly to determine pitch movement, namely, angular movement of the imaging lens assembly about a first axis orthogonal to and intersecting the optical axis and to determine yaw movement, namely, angular movement of the imaging lens assembly along a second axis orthogonal to and intersecting the optical axis and a compensation element moveable with respect to the first and second axes to compensate for the determined yaw and pitch movements of the imaging lens assembly, the image stabilization system being selectively actuatable; and
a target ranging system coupled to the image stabilization system, the target ranging system determining a distance between the imaging lens assembly and the target bar code, when the determined distance exceeds a threshold value, the image stabilization system being actuated.

12. The imaging-based bar code reader of claim 11 wherein the first axis is a horizontal axis through the imaging lens assembly and the second axis is a vertical axis through the imaging lens assembly and the first and second axes intersect.

13. The imaging-based bar code reader of claim 12 wherein the compensation element includes a compensation lens that moves along the first axis to compensate for determined yaw movement and along the second axis to compensate for determined pitch movement.

14. The imaging-based bar code reader of claim 13 wherein the compensation lens is supported for movement in a plane orthogonal to the optical axis within a lens holder of the imaging lens assembly.

15. The imaging-based bar code reader of claim 11 wherein the sensor assembly includes a first sensor to determine angular velocity of the imaging lens assembly with respect to the first axis and a second sensor to determine angular velocity of the imaging lens assembly with respect to the second axis.

16. The imaging-based bar code reader of claim 15 wherein the first and second sensors are disposed on a lens holder of the imaging lens assembly.

17. The imaging-based bar code reader of claim 14 wherein a drive system is operatively coupled to the compensation lens to move the lens along the second axis in a direction to oppose determined angular movement about the first axis to counteract pitch movement and to move the lens along the first axis in a direction to oppose determined angular movement about the second axis to counteract yaw movement.

18. The imaging-based bar code reader of claim 17 wherein the drive system includes a first motor operatively connected to the compensation lens to drive the lens about the second axis and a second motor operatively connected to the compensation lens to drive the lens about the first axis.

19. A method of imaging a target bar code within a field of view of an imaging-based bar code reader, the steps of the method comprising:
a) providing an imaging system including an imaging lens assembly and a sensor array, the imaging lens assembly focusing light from the field of view onto the sensor array to image a target bar code within the field of view, the imaging system generating a series of image frames including the imaged target bar code, the imaging lens assembly defining an optical axis; an image stabilization system including a sensor assembly to determine pitch movement, namely, angular movement of the imaging lens assembly about a first axis orthogonal to and intersecting the optical axis and to determine yaw movement, namely, angular movement of the imaging lens assembly along a second axis orthogonal to and intersecting the optical axis and a compensation element moveable with respect to the first and second axes to compensate for the determined yaw and pitch movements of the imaging lens assembly, the image stabilization system being selectively actuatable; and a target ranging system coupled to the image stabilization system, the target ranging system determining a distance between the imaging lens assembly and the target bar code, when the determined distance exceeds a threshold value, the image stabilization system being actuated when imaging the target bar code; and
b) activating the imaging system and the image analysis system and imaging the target bar code.

20. An imaging-based bar code reader comprising:
an imaging system means including an imaging lens assembly and a sensor array, the imaging lens assembly focusing light from a field of view onto the sensor array to image a target bar code within the field of view, the imaging system means generating a series of image frames including the imaged target bar code, the imaging lens assembly defining an optical axis;
an image stabilization system means including a sensor assembly means to determine pitch movement, namely, angular movement of the imaging lens assembly about a first axis orthogonal to and intersecting the optical axis and to determine yaw movement, namely, angular movement of the imaging lens assembly along a second axis orthogonal to and intersecting the optical axis and a compensation element means moveable with respect to the first and second axes to compensate for the determined yaw and pitch movements of the imaging lens assembly, the image stabilization system means being selectively actuatable; and
an image analysis system means coupled to the image stabilization system, the image analysis system analyzing blurring of the imaged target bar code, when the blurring exceeds a threshold value, the image stabilization system means being actuated.
